(19) United States
(12) Patent Application Publication
(10) Pub. No.: US 2015/0068007 A1
(43) Pub. Date: Mar. 12, 2015

(54) Pump Plunger Alignment Device

(71) Applicant: Kenneth James Conques, Scott, LA (US)

(72) Inventor: Kenneth James Conques, Scott, LA (US)

(21) Appl. No.: 14/025,281

(22) Filed: Sep. 12, 2013

(51) Int. Cl. F16J 1/00; B23P 19/04

(52) U.S. Cl. CPC F16J 1/005; B23P 19/04
USPC 29/402.08; 29/700

(57) ABSTRACT

A plunger shoe for insertion and removal of plungers in a plunger pump comprises an elongated trough having an enlarged width section at one end. When inserted into the cylinder of a plunger pump, the trough rests within the cylinder and the enlarged width section rests in a corresponding section in the cylinder head. A plunger may be easily slid along the valley of the trough and through the opening in the seal element in the cylinder. A hole in the enlarged width section forms a handle.

### CROSS REFERENCE TO RELATED APPLICATION S

Not applicable.

### BACKGROUND

### Field of the Invention

This invention relates to apparatus and methods for removal and replacement of pump plungers, such as those used in connection with mud pumps used in oil and gas well drilling and other applications.

What is commonly known as a “plunger pump” is a reciprocating, positive displacement pump comprising a power end and a fluid end. The power end, generally, has as its final output a reciprocating “pony rod.” The pony rod is connected to a plunger, akin to a piston in an internal combustion engine, which reciprocates in the “fluid end.” Intake valves permit fluid, whether it be drilling mud, water, or any other suitable fluid, to flow into a fluid chamber, when the plunger strokes away from the fluid chamber. When the plunger is stroked back toward the fluid chamber, the intake valves close, and the discharge valves open, permitting the fluid to be pushed out of the chamber. This sequence creates the pumping action.

In many applications for use of plunger pumps, including but not limited to those involving the pumping of drilling mud in connection with oil and gas well drilling, the fluid being pumped is solids-laden. As a result of the reciprocating motion in such environment, plungers periodically wear out and must be replaced.

Generally, removal of a plunger involves disconnecting it from the pony rod and then pulling it out through an opening in the cylinder housing, by removing a suction cover plate and retaining nut on the cylinder housing. Removal of the plunger generally poses relatively few problems. Replacement of the plunger is more problematic. Plungers can be quite heavy, for example approximately 70 lbs. apiece. The plunger must be inserted into the cylinder housing a considerable distance to enter the cylinder, then through an opening in a seal element, which fits around the plunger and provides a fluid seal around the plunger as it reciprocates back and forth in the cylinder. In order to seal properly around the plunger, the seal element must be very tight, and it is not easy to force the plunger through the opening in the seal element. Adding to the difficulty in stabbing the plunger through the seal element is the fact that the plunger is inserted a relatively large distance into a relatively inaccessible area within the cylinder head, through the cylinder chamber, then into the cylinder and into and through the seal element opening.

The challenge lies in aligning the heavy plunger with the seal element opening. While the forward end of the plunger is usually beveled to assist in stabbing it through the opening, it is still difficult to align the plunger properly with the opening in the seal element and overcome the resistance which the very tight fit of the seal element poses. In addition, there is the ever present risk of damaging the highly polished outer surface of the plunger by striking the interior surfaces of the pump, etc.

There is a need for an apparatus which supports the plunger as it is inserted through the cylinder head and into the cylinder, and aligns the plunger with the opening in the seal element to ease stabbing of the plunger through the seal element.

### SUMMARY OF THE INVENTION

Apparatus embodying the principles of the present invention comprises an elongated trough member having a valley with dimensions and outer contours which engage surfaces and openings in a plunger pump. For purposes of this application, the trough member is referred to as a “plunger shoe.” The plunger shoe is inserted through the opening in the cylinder head, spans the cylinder chamber, and has a first end which rests in the cylinder of the pump. The second end of the plunger shoe comprises one or more shoulder sections with larger dimensions which engage and rest in corresponding profiles in the opening in the cylinder head.

When the plunger shoe is fully inserted into the pump, the inner surface of the trough valley is substantially aligned with the lower edge of the seal element opening. A plunger can then be placed in the valley of the plunger shoe and pushed forward, fully supported by the plunger shoe and substantially aligned with the seal element opening, and easily pushed through the seal element opening. A hole in the second end of the plunger shoe forms a convenient handle for insertion and removal of the plunger shoe.

### BRIEF DESCRIPTION OF THE DRAWINGS

FIGS. 1 and 2 are views of a representative prior art plunger pump, with which the plunger shoe of the present invention may be used.

FIG. 3 is a perspective view in cutout of a portion of a plunger pump with the plunger shoe and a plunger in exploded position.

FIG. 4 is the view of FIG. 3 with the plunger shoe in place within the pump, and a plunger in place in the plunger shoe.

FIG. 5 is a simplified cross section view of the cylinder and cylinder chamber section of a pump, with a plunger shoe and plunger in position to be stabbed into the seal element opening.

FIG. 6 is a top view of an embodiment of the plunger shoe.

FIG. 7 is a perspective view of one embodiment of the plunger shoe.

FIG. 8 is another, rotated perspective view of the plunger shoe of FIG. 7.

FIG. 9 is a perspective view of another embodiment of the plunger shoe.

FIG. 10 is another, rotated perspective view of the plunger shoe of FIG. 9.

### DESCRIPTION OF THE PRESENTLY PREFERRED EMBODIMENTS(S)

While various forms of plunger shoes can embody the principles of the present invention, with reference to the drawings some of the presently preferred embodiments can be described.

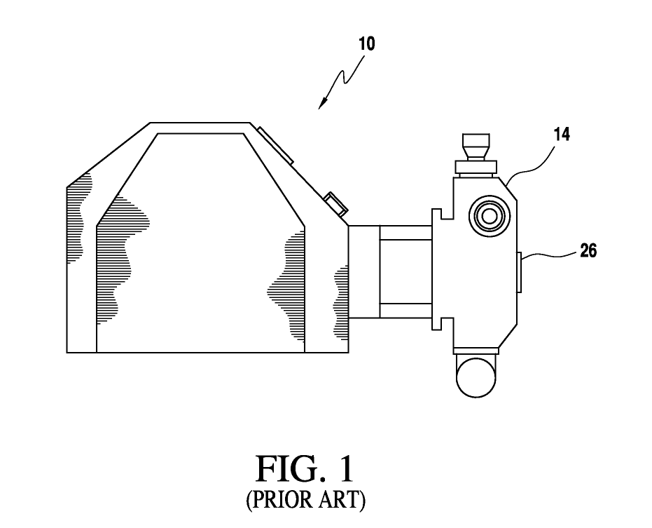

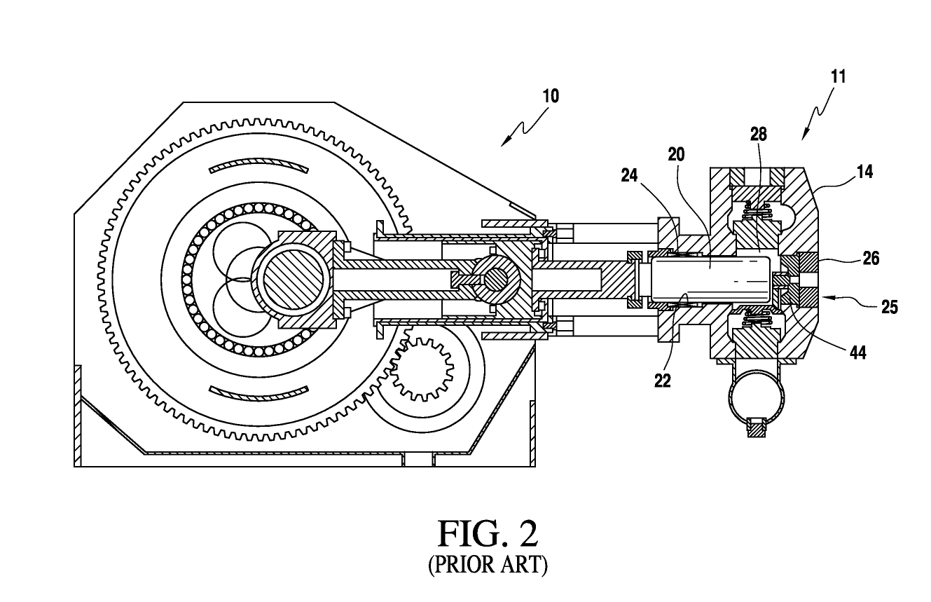

FIGS. 1 and 2 are views of a representative prior art plunger pump 10. FIG. 1 is a side view. FIG. 2 is a cross section view of a representative plunger pump, in connection with which the plunger shoe of the present invention may be beneficially used. The fluid end of pump 10, noted generally as 11, comprises a cylinder 22, in which plunger 20 reciprocates. A suction cover 44 and retaining nut 26 can be removed to provide access to cylinder chamber 28, cylinder 22 and plunger 20, including for removal and replacement of plunger 20. As can be seen in FIG. 2, seal element 24 is disposed within cylinder 22, and has an opening within which plunger 20 reciprocates. with seal element 24 providing a fluid and pressure tight seal around plunger 20. A cylinder chamber 28 is a generally enlarged cross section area in cylinder housing 14. Opening 25 in cylinder housing 14, into which suction cover 44 and retaining nut 22 fit, generally has at least two diameters, with a larger diameter at the outer end, as can be seen in FIG. 2 and in more detail in later drawings.

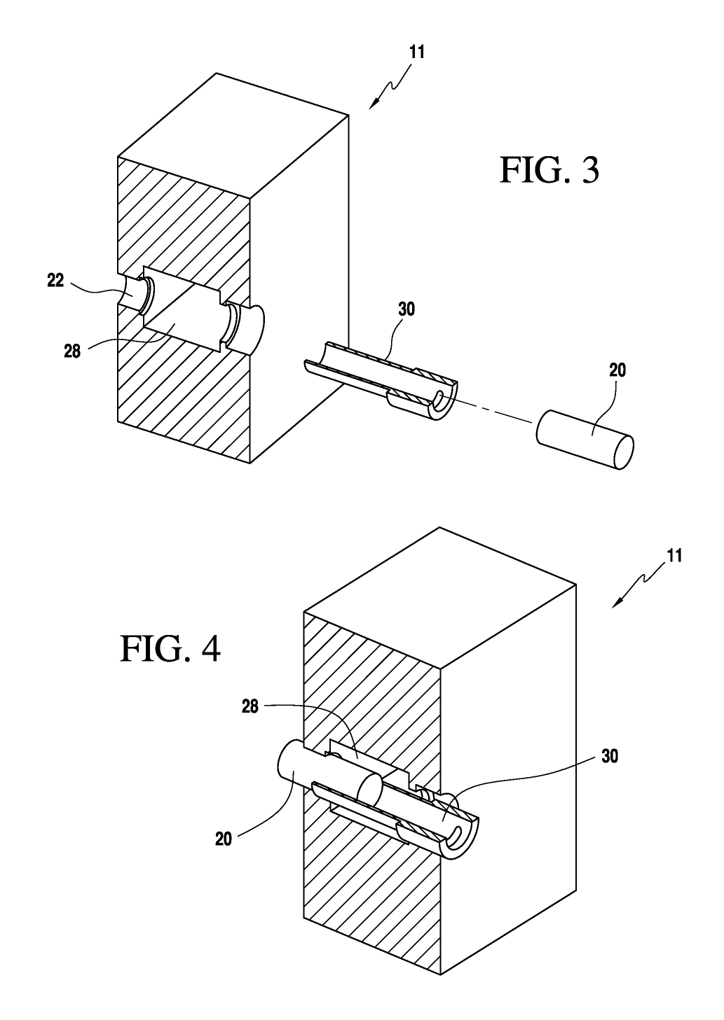

FIG. 3 is a simplified perspective view in partial cross section of fluid end 11, with plunger shoe 30 and plunger 20 in an exploded position. FIG. 4 is another simplified perspective view in partial cross section of fluid end 11, with plunger shoe 30 and plunger 20 in position within cylinder 22 in preparation for stabbing plunger 20 through the opening in seal element 24.

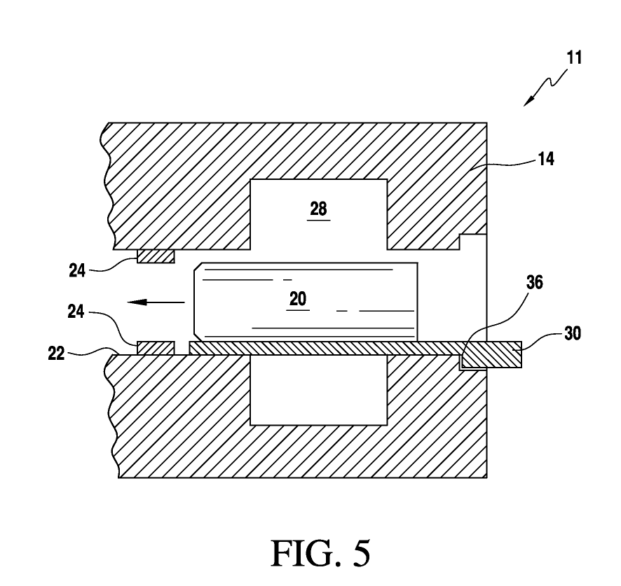

FIG. 5 is another simplified side view of a section of a plunger pump 10, namely the fluid end 11 and cylinder housing 14 thereof. Seal element 24 is disposed in cylinder 22. As can be seen, with plunger shoe 30 in place in cylinder 22, plunger 20 is held and supported in cylinder 22, and is held at substantially the elevation of the lower edge of the opening in seal element 24; said another way, plunger 20 is substantially axially aligned with the opening in seal element 24. First shoulder 36 of plunger shoe 30 fits within corresponding diameters in the opening of cylinder housing 14.

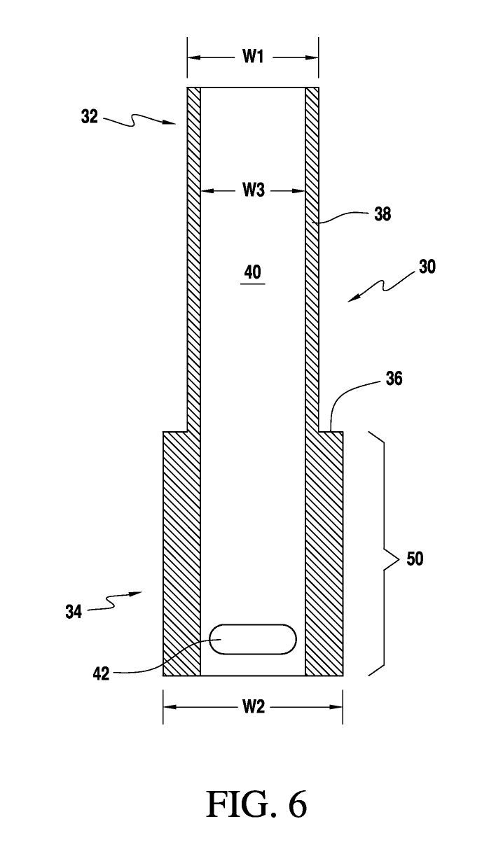

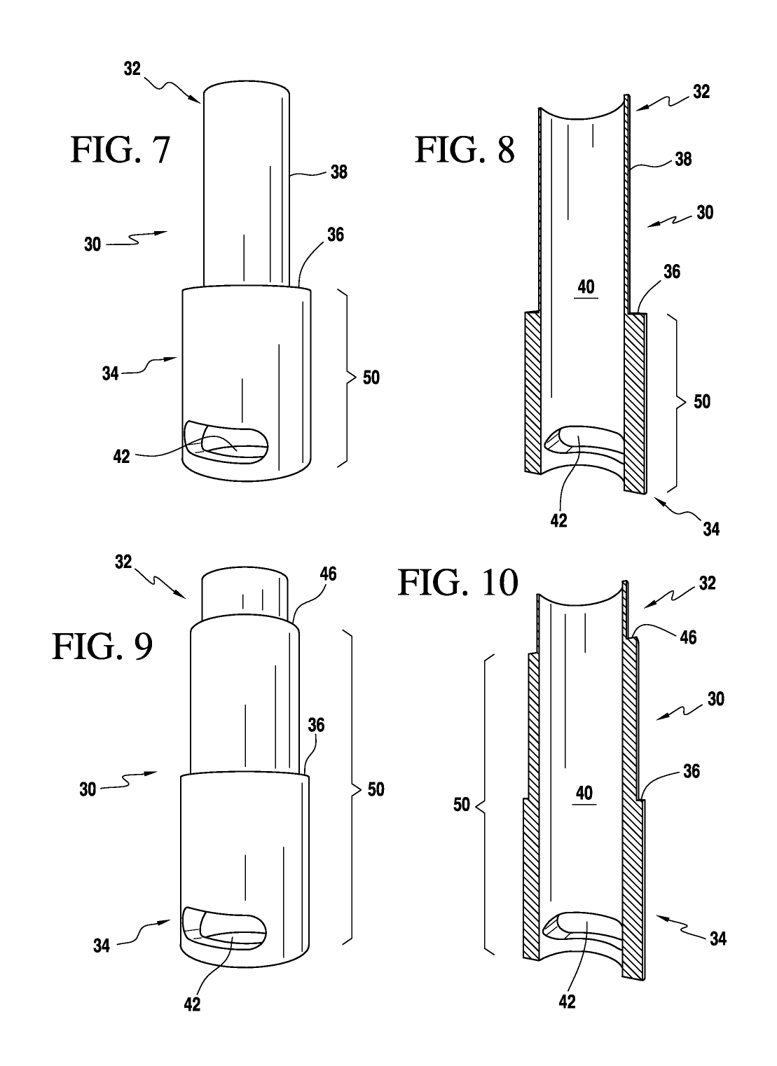

Referring to FIGS. 6-8, plunger shoe 30 comprises an elongated trough 38 comprising first and second ends 32 and 34. A valley 40 runs the length of trough 38. First end has width W1. Second end 34 comprises an enlarged width section 50 (with width W2), forming a first shoulder 36. As can be seen in previous drawings, especially FIGS. 3-5, enlarged width section 50 and first shoulder 36 fit within opening 25 to hold plunger shoe 30 stable while plunger 20 is inserted.

The width W1 of trough 38 approximately corresponds to the diameter of cylinder 22. The width W3 of valley 40 approximately corresponds to the diameter of plunger 20. This relationship permits plunger shoe 30 to rest firmly within cylinder 22, while supporting plunger 20 so that it is substantially axially aligned with the opening in seal element 24. FIG. 5 shows this arrangement. With plunger 20 so supported, it can be easily forced into the opening in seal element 24

Certain makes/models of plunger pumps 10 have more than two diameters in opening 25, opening of cylinder housing 14, for example three diameters. For such pumps, plunger shoe 30 comprises an enlarged width section 50 having two larger diameters, forming first and second shoulders 36 and 46, as can be seen in FIGS. 9 and 10.

Preferably, enlarged width section 50 comprises a hole 42 forming a handle, facilitating placement and removal of plunger shoe 30 within cylinder 22, and making it easy to carry, etc.

Use of the Plunger Shoe

To use plunger shoe 30 in connection with installation of a plunger 20, plunger shoe 30 is placed within cylinder 22 of a plunger pump 10, into the position shown in FIGS. 4 and 5. Plunger 20 is placed in valley 40 of trough 38, then pushed forward until it is at least partially through the opening in seal element 24. A lubricant such as grease may be applied to the outside of plunger 20 and/or to the valley 40 of plunger shoe 30, to ease sliding plunger 20 thereon. Plunger shoe 30 can then be removed and further steps taken to connect the plunger to the pony arm, etc., as is well known in the art.

Removal of a plunger 20 may be done by substantially reversing these steps, as may be readily understood.

Materials, Manufacture of the Plunger Shoe

A variety of materials could be used to make plunger shoe 30, including metals and non-metals such as high strength plastics, composites, etc. One preferred material is an aluminum alloy. Plunger shoe 30 can be made by a combination of techniques known in the art, including boring, machining, etc.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, the dimensions of the plunger shoe, including length, outer width and valley width, can be varied to suit particular applications. The number, size, and shape of the enlarged sections may be altered to suit particular pump models. Materials may be changed to optimize manufacturing costs, etc.

Therefore, the scope of the invention is to be determined not by the illustrative examples set forth above, but by the appended claims and their legal equivalents.

I claim:

1. An apparatus for aligning a plunger with an opening in the plunger seal element of a plunger pump, comprising:
an elongated trough having a uniform valley dimension along its length and first and second sections, said first section having a width substantially equal to a diameter of a cylinder in said plunger pump, said second section having a larger width substantially equal to a diameter in an opening in a cylinder head of said pump and forming a shoulder between said first and second sections, further comprising a hole in said second section forming a handle,
wherein when said trough is disposed in said pump cylinder and a plunger is disposed in said valley, said plunger is substantially axially aligned with said opening in said plunger seal element.

2. The apparatus of claim 1, wherein said second section comprises two widths, each successively larger than said first section width.

3. A method for replacement of a plunger in a plunger pump, wherein said plunger pump comprises a cylinder with a seal element therein, comprising the steps of:
a. providing an apparatus comprising an elongated trough having a uniform valley dimension along its length and first and second sections, said first section having a width substantially equal to a diameter of a cylinder in said plunger pump, said second section having a larger width substantially equal to a diameter in an opening in a cylinder head of said pump and forming a shoulder between said first and second sections, further comprising a hole in said second section forming a handle;
b. inserting said apparatus into said cylinder, such that said first section is disposed in said cylinder and said section section is disposed in said opening in said cylinder head;
c. placing a pump plunger into said valley; and
d. pushing said pump plunger at least partially through an opening in said seal element.
